(19) United States
(12) Patent Application Publication
(10) Pub. No.: US 2016/0313596 A1
(43) Pub. Date: Oct. 27, 2016

(54) MOBILE DEVICE

(71) Applicant: Xiaomi Inc., Beijing (CN)

(72) Inventors: Lixin AI, Beijing (CN); Kesheng YAN, Beijing (CN); Jinchao LI, Beijing (CN); Shaoxing HU, Beijing (CN)

(73) Assignee: Xiaomi Inc.

(21) Appl. No.: 15/076,248

(22) Filed: Mar. 21, 2016

(30) Foreign Application Priority Data
Apr. 21, 2015 (CN) 201510191110.5

(51) Int. Cl. G02F 1/1333

(52) U.S. Cl. CPC G02F 1/133308

(57) ABSTRACT

A mobile device includes a frame structure and a screen module. The frame structure includes a protrusion structure protruding inwardly. The screen module includes a glass panel having an edge region and an LCD display module adhered to a bottom surface of the glass panel. The LCD display module includes a border frame corresponding to the edge region of the glass panel. The edge region and the protrusion structure are configured so that a vertical projection region of the border frame is located within a vertical projection region of the protrusion structure.

### CROSS-REFERENCE TO RELATED APPLICATIONS

This application claims priority to Chinese Application No. 201510191110.5, filed on Apr. 21, 2015, the entire contents of which are incorporated herein by reference.

### TECHNICAL FIELD

The disclosure relates to terminal technology and, more particularly, to mobile devices.

### BACKGROUND

As screen sizes of mobile devices are becoming larger and larger, the sizes of the mobile devices themselves have to be increased accordingly. Although a larger screen can provide better visual effect, the increased size of the mobile device may cause difficulty in, e.g., carrying or gripping the mobile device, and thus adversely affect the user's experience.

### SUMMARY

In accordance with the present disclosure, there is provided a mobile device including a frame structure and a screen module. The frame structure includes a protrusion structure protruding inwardly. The screen module includes a glass panel having an edge region and an LCD display module adhered to a bottom surface of the glass panel. The LCD display module includes a border frame corresponding to the edge region of the glass panel. The edge region and the protrusion structure are configured so that a vertical projection region of the border frame is located within a vertical projection region of the protrusion structure.

It will be understood, the above brief description and the following details are only illustrative and explanatory, and the disclosure is not limited thereto.

### BRIEF DESCRIPTION OF THE DRAWINGS

The accompanying drawings, which are incorporated in and constitute a part of this application, illustrate embodiments of the present disclosure and together with the description serve to explain the principle of the present disclosure.

FIG. 1 shows a structure diagram of a mobile device in the related art.

FIG. 2 shows a structure diagram of a mobile device in a state of assembly, according to an exemplary embodiment of the disclosure.

FIG. 3 shows a structure diagram of the mobile device shown in FIG. 2 in a subsequent state of assembly, according to an exemplary embodiment of the disclosure.

FIG. 4 shows a structure diagram of a screen module of the mobile device shown in FIG. 2, according to an exemplary embodiment of the disclosure.

FIG. 5 shows a schematic diagram of a screen module assembled with a frame structure according to an exemplary embodiment of the disclosure.

FIG. 6 shows a structure diagram of a mobile device according to another exemplary embodiment of the disclosure.

FIG. 7 shows a structure diagram of a mobile device according to another exemplary embodiment of the disclosure.

### DETAILED DESCRIPTION

Hereinafter, exemplary embodiments will be explained with examples shown in the accompanying drawings. In the drawings, unless otherwise indicated, identical or similar elements may be denoted by same reference numerals. Implementations of the exemplary embodiments described below are not intended to exclusively include all implementations of the disclosure. Instead, they are merely examples of devices and methods consistent with those defined in the claims and some aspects of the disclosure.

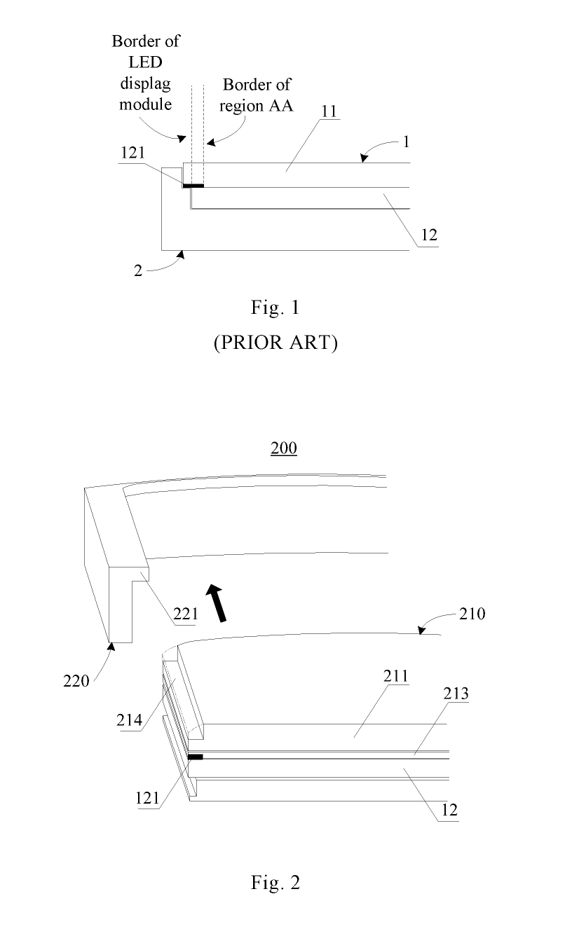

FIG. 1 is a structure diagram of a conventional mobile device. As shown in FIG. 1, in the conventional mobile device, a screen module 1 is assembled with a frame structure 2. A stepped structure is inwardly formed at an edge of the frame structure 2, and thus edges of a glass panel 11 in the screen module 1 can be placed at the stepped structure. An LCD display module 12 is adhered to the glass panel 11 on the lower portion of the glass panel 11. In FIG. 1, the left one of the two dashed lines indicates an actual border of the LCD display module 12. However, as shown in FIG. 1, a border frame 121 is formed around the LCD display module 12, covering the actual border of the LCD display module 12. The border frame 121 may be black or another color. Therefore, a region for actually displaying content, also referred to as an active area (region AA), is smaller than the area of the LCD display module 12. In FIG. 1, the right one of the two dashed lines indicates a border of the region AA. That is, the border frame 121 limits the display area of the screen.

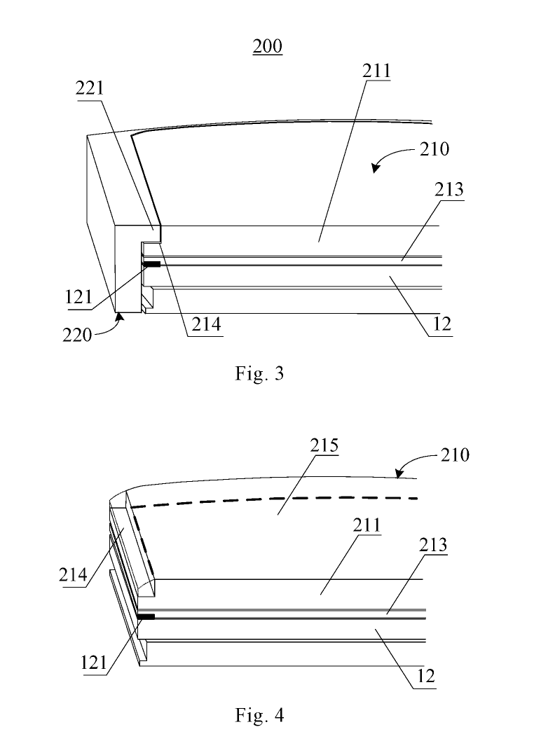

FIGS. 2 and 3 are structure diagrams of a mobile device 200 according to an exemplary embodiment of the disclosure. As shown in FIGS. 2 and 3, the mobile device 200 includes a screen module 210 and a frame structure 220. FIG. 2 shows the state before the screen module 210 and the frame structure 220 are assembled, while FIG. 3 shows the subsequent state after the screen module 210 and the frame structure 220 are assembled together.

As shown in FIGS. 2 and 3, the frame structure 220 has a top portion protruding inwardly to form a protrusion structure 221. The screen module 210 includes a glass panel 211 and the LCD display module 12 adhered to a bottom surface of the glass panel 211. For example, the LCD display module 12 can be adhered to the glass panel 211 by a glue tape, such as an optical adhesive, or a liquid glue. A glue layer 213 is formed between the glass panel 211 and the LCD display module 12. The border frame 121 of the LCD display module 12 corresponds to an edge region 214 of the glass panel 211. The edge region 214 cooperates with the protrusion structure 221, so that a vertical projection region of the border frame 121 is located within a vertical projection region of the protrusion structure 221 when the screen module 210 is assembled with the frame structure 220, as shown in FIG. 3.

As shown in FIGS. 2 and 3, the vertical projection region of the border frame 121 is located within the vertical projection region of the protrusion structure 221, and thus the border frame 121 can be blocked. FIG. 4 illustrates the screen module 210 including a dashed line that indicates the border of a region AA 215. Consequently, when a user uses the mobile device 200, no border caused by the border frame 121 is visible outside of the region AA 215, so that a screen occupation ratio of the region AA 215 is increased, and an aesthetic feeling of the mobile device 200 can be improved.

1. Stepped Edge

In some embodiments, the protrusion structure 221 has a quadrilateral cross section, and the edge region 214 has a corresponding stepped structure. Moreover, when the screen module 210 is assembled with the frame structure 220, a top surface of the edge region 214 is adhered to a bottom surface of the protrusion structure 221, or a side surface of the edge region 214 is adhered to a side surface of the protrusion structure 221.

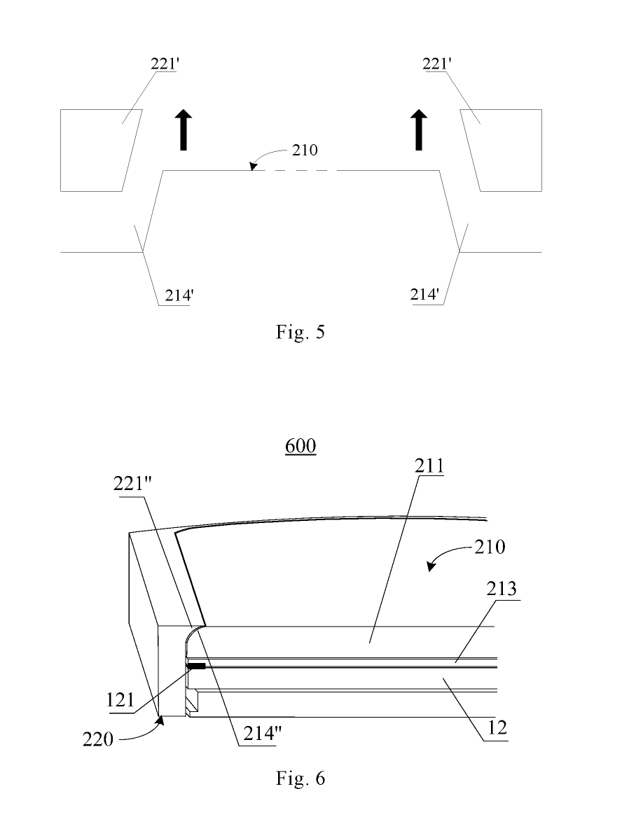

For example, as shown in FIGS. 2 and 3, the protrusion structure 221 has a rectangular cross section, i.e., an angle between the bottom and side surfaces of the protrusion structure 221 is a right angle. In another example shown in FIG. 5, a protrusion structure 221′ has a trapezoidal cross section that is wider at an upper end and narrower at a lower end. Correspondingly, a side surface of an edge region 214′ forms a slope, with the bottom portion of the side surface extending outward. In this example, the protrusion structure 221′ and the edge region 214′ having a stepped structure are configured to have corresponding inclined surfaces, which cooperate with each other to guide an assembling direction during assembling the screen module 210 and the frame structure 220.

2. Arch-Shaped Edge

FIG. 6 shows a mobile device 600 according to another exemplary embodiment. The mobile device 600 is similar to the mobile device 200, except that in the mobile device 600, a top surface of an edge region 214″ of the glass panel 211 is arch-shaped, and correspondingly a bottom surface of a protrusion structure 221″ is also arch-shaped to cooperate with the arch-shaped top surface of the edge region 214″. As shown in FIG. 6, when the screen module 210 is assembled with the frame structure 220, the top surface of the edge region 214″ is adhered to the bottom surface of the protrusion structure 221″.

The above terms “stepped” and “arch-shaped” are only illustrative. It would now be understood that the edge region 214 and the protrusion structure 221 may cooperate with each other in other configurations, which are also applicable to the solutions of the disclosure.

3. Configuration of the Frame Structure 220

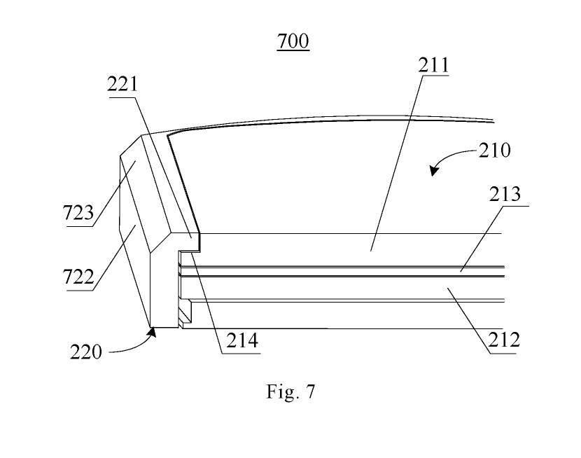

In the examples described above, and as shown in FIGS. 1-4 and 6, an outer surface of the frame structure 220 includes a vertical side wall. FIG. 7 shows a mobile device 700 according to another exemplary embodiment. The mobile device 700 is similar to the mobile device 200, except that in the mobile device 700, the side wall of the frame structure 220 includes a vertical portion 722 and an inclined portion 723.

With the two-portion side wall shown in FIG. 7, the strength of the frame structure 220 is increased. Consequently, if the mobile device 700 is dropped or pressed, the mobile device 700 can withstand the corresponding impact or pressure, and thus damage to the mobile device 700 can be avoided or reduced. In some embodiments, the inclined portion 723 can instead be an arc portion (not shown).

According to the disclosure, the protrusion structure 221 is formed at the top of the frame structure 220, and the edge region 214 of the screen module 210 cooperates with the protrusion structure 221 (the edge region 214 is adhered to the protrusion structure 221), so that the protrusion structure 221 can block the border region 121 of the LCD display module 12 when the screen module 210 is assembled and fixed with the frame structure 220. Accordingly, occupation of the screen region by the border region 121 can be avoided. Therefore, the screen occupation ratio of the mobile device 700 can be increased, and the user experience can be improved.

Other embodiments of the present disclosure will be apparent to those skilled in the art from consideration of the specification and practice of the disclosure. This application is intended to cover any variations, usages, or modifications of the disclosure which are consistent with the general principle of the disclosure, and includes the common knowledge or customary means in the art. The embodiments and the description are merely illustrative, and the true scope and spirit of the disclosure should only be defined by the following claims.

It would be appreciated, the disclosure is not limited to the specific structures described above and illustrated in the drawings, and various modifications and changes may be formed without deviating the scope of the disclosure. The scope of the disclosure is only limited by the following appended claims.

What is claimed is:

1. A mobile device, comprising:
a frame structure including a protrusion structure protruding inwardly; and
a screen module including:
a glass panel having an edge region; and
an LCD display module adhered to a bottom surface of the glass panel, the LCD display module including a border frame corresponding to the edge region of the glass panel,
wherein the edge region and the protrusion structure are configured so that a vertical projection region of the border frame is located within a vertical projection region of the protrusion structure.

2. The device according to claim 1, wherein the edge region of the glass panel includes a stepped structure.

3. The device according to claim 2, wherein:
the protrusion structure has a quadrilateral cross section, and
a top surface of the stepped structure is adhered to a bottom surface of the protrusion structure or a side surface of the stepped structure is adhered to a side surface of the protrusion structure.

4. The device according to claim 3, wherein the side surface of the stepped structure forms a slope extending outwardly.

5. The device according to claim 1, wherein a top surface of the edge region of the glass panel is arch-shaped.

6. The device according to claim 5, wherein:
a bottom surface of the protrusion structure is arch-shaped to cooperate with the edge region, and
the top surface of the edge region is adhered to the bottom surface of the protrusion structure.

7. The device according to claim 6, wherein a side surface of the frame structure includes a vertical portion and an inclined portion formed between the vertical portion and the protrusion structure.
